(19) United States
(12) Patent Application Publication
(10) Pub. No.: US 2021/0226484 A1
(43) Pub. Date: Jul. 22, 2021

(54) ELECTRIC MACHINE SYSTEM

(71) Applicant: Baker Hughes Oilfield Operations LLC, Houston, TX (US)

(72) Inventors: David Allan Torrey, Ballston Spa, NY (US); Jeremy Daniel Van Dam, West Coxsackie, NY (US); Weijun Yin, Schenectady, NY (US); Patel Bhageerath Reddy, Schenectady, NY (US); Michael Franklin Hughes, Oklahoma City, OK (US); Joseph John Zierer, Schenectady, NY (US)

(73) Assignee: Baker Hughes Oilfield Operations LLC, Houston, TX (US)

(21) Appl. No.: 17/222,932

(22) Filed: Apr. 5, 2021

Related U.S. Application Data
(63) Continuation of application No. 14/927,299, filed on Oct. 29, 2015, now abandoned.

(51) Int. Cl. H02K 1/16; H02K 15/085; H02K 1/14; H02K 15/06

(52) U.S. Cl. CPC H02K 1/16; H02K 15/066; H02K 1/148; H02K 15/085

(57) ABSTRACT

A system includes a stator core, which includes a plurality of teeth and a plurality of bridges. The plurality of teeth are disposed about an axis of the stator core, wherein each tooth of the plurality of teeth extends in a radial direction from a proximal end to a distal end. Each bridge of the plurality of bridges is disposed between two adjacent teeth and connects the proximal ends of the two teeth. The plurality of teeth and the plurality of bridges define a plurality slots, each having a proximal end and a distal end, wherein the proximal end of each slot is closed and the distal end of each slot is open.

### RELATED APPLICATIONS

This application is a continuation of U.S. patent application Ser. No. 14/927,299 filed Oct. 29, 2015, entitled “Electric Machine System,” the disclosure of which is herein incorporated by reference.

### BACKGROUND

The subject matter disclosed herein relates to electric machines, and more specifically to electric machines for use with electric submersible pumps (ESPs) in oil and gas applications.

In typical oil and gas drilling applications a well bore is drilled to reach a reservoir. The well bore may include multiple changes in direction and may have sections that are vertical, slanted, or horizontal. A well bore casing is inserted into the well bore to provide structure and support for the well bore. The oil, gas, or other fluid is then pumped out of the reservoir, through the well bore casing, and to the surface, where it is collected. One way to pump the fluid from the reservoir to the surface is with an electrical submersible pump (ESP), which uses an electric motor in the well bore casing to drive a pump.

Given the design constraints imposed by the geometry of the well bore casing, electric motors used with ESP systems typically are long with small diameters. Manufacturing electric motors is typically a simple process. Windings are inserted into the stator slots through slot openings that face the rotor. However, motors for ESPs typically have closed slots which force the windings to be created by a process similar to sewing, which involves threading wire coils through slots that run the entire length of the electric motor. Unfortunately, for electric motors with long lengths and small diameters, this process can be time consuming and expensive if the wire insulation is stripped during manufacturing, necessitating the use of replacement wire coils.

### BRIEF DESCRIPTION

Certain embodiments commensurate in scope with the original claims are summarized below. These embodiments are not intended to limit the scope of the claims, but rather these embodiments are intended only to provide a brief summary of possible forms of the claimed subject matter. Indeed, the claims may encompass a variety of forms that may be similar to or different from the embodiments set forth below.

In one embodiment, a system includes a stator core, which includes a plurality of teeth and a plurality of bridges. The plurality of teeth are disposed about an axis of the stator core, wherein each tooth of the plurality of teeth extends in a radial direction from a proximal end to a distal end. Each bridge of the plurality of bridges is disposed between two adjacent teeth and connects the proximal ends of the two teeth. The plurality of teeth and the plurality of bridges define a plurality slots, each having a proximal end and a distal end, wherein the proximal end of each slot is closed and the distal end of each slot is open.

In a second embodiment, a system includes a stator and a rotor. The stator includes a stator core, a plurality of windings, and a plurality of magnetic keystones. The stator core includes a plurality of teeth and a plurality of bridges. The plurality of teeth are disposed about an axis of the stator core, wherein each tooth of the plurality of teeth extends in a radial direction from a proximal end to a distal end. Each bridge of the plurality of bridges is disposed between two adjacent teeth and connects the proximal ends of the two teeth. The plurality of teeth and the plurality of bridges define a plurality slots, each having a proximal end and a distal end, wherein the proximal end of each slot is closed and the distal end of each slot is open. The plurality of windings are disposed within the slots and each magnetic keystone of the plurality of magnetic keystones is disposed between the distal ends of two adjacent teeth. The rotor is disposed within the stator and is configured to rotate about the axis of the stator core.

In a third embodiment, a method of manufacturing an electric machine stator includes providing a stator core, the stator core having a plurality of teeth disposed about an axis of the stator core, each tooth of the plurality of teeth extending in a radial direction from a proximal end to a distal end, and a plurality of bridges, wherein each bridge of the plurality of bridges is disposed between two adjacent teeth and connects the proximal ends of the two teeth, wherein the plurality of teeth and the plurality of bridges define a plurality slots, inserting a first winding into a first slot of the plurality of slots, and coupling a first magnetic keystone to the stator core to block removal of the first winding.

### BRIEF DESCRIPTIONS OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic of a hydrocarbon extraction system extracting fluid from an underground reservoir;

FIG. 2 is a partial cross-sectional perspective view of an embodiment of an electric motor;

FIG. 3 is a cross-sectional view of an embodiment of a closed slot stator;

FIG. 4 is a cross-sectional view of an embodiment of a stator core;

FIG. 5 is a cross-sectional view of an embodiment of a stator core with windings installed in the slots;

FIG. 6 is a cross-sectional view of a stator core with windings installed in the slots and magnetic keystones closing the distal ends of the slots in accordance with aspects of the present disclosure;

FIG. 7 is a perspective view of the stator core mounted on a mandrel, supported on either end by a bearing pedestal, and surrounded by a cradle and cover in accordance with aspects of the present disclosure;

FIG. 8 is a perspective view of windings being installed through the distal ends of the slots in the stator core in accordance with aspects of the present disclosure;

FIG. 9 is a perspective view of magnetic keystones being installed over the windings, closing the slots in the stator core in accordance with aspects of the present disclosure;

FIG. 10 is a perspective view of two slots having windings and magnetic keystones installed rotated up under the cover in accordance with aspects of the present disclosure;

FIG. 11 is a perspective view of a stator with windings and magnetic keystones installed in all stator core slots in accordance with aspects of the present disclosure;

FIG. 12 is a perspective view of a populated stator core with band clamps around either end in accordance with aspects of the present disclosure;

FIG. 13 is a perspective view of a populated stator core removed from the cradle and cover, with an additional band clamp installed in accordance with aspects of the present disclosure;

FIG. 14 is a perspective view of a populated stator core being inserted into a stator housing in accordance with aspects of the present disclosure;

FIG. 15 is a cross-sectional view of a slot filled with windings in accordance with aspects of the present disclosure;

FIG. 16 is a cross-sectional view of an embodiment with joined magnetic keystones in accordance with aspects of the present disclosure; and

FIG. 17 is a flow chart for a process of manufacturing or assembling a stator in accordance with aspects of the present disclosure.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

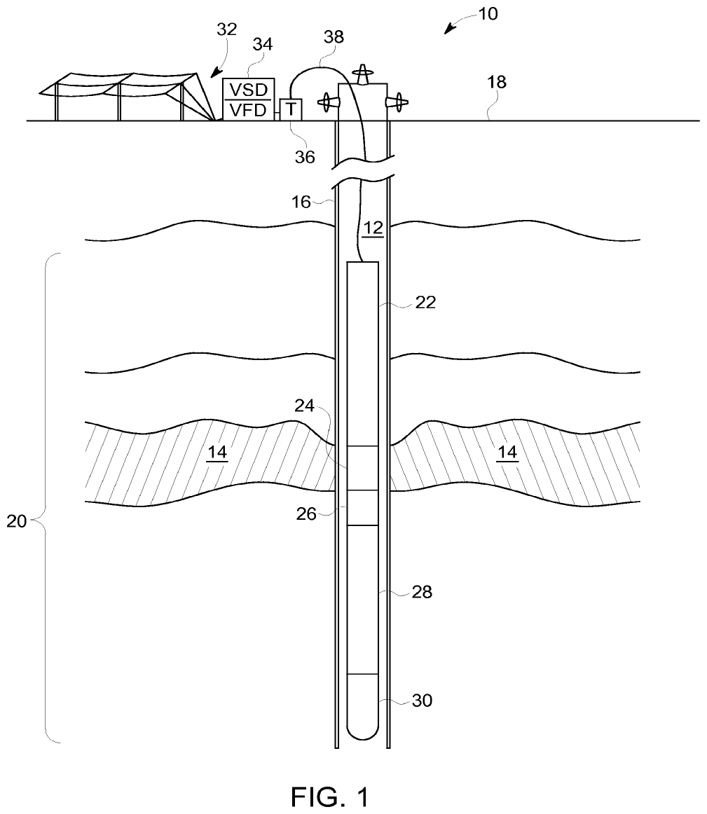

FIG. 1 is a schematic of a hydrocarbon extraction system (e.g., well 10) extracting fluid (e.g., oil, gas, etc.) from an underground reservoir 14. As shown in FIG. 1, a well bore 12 may be drilled in the ground toward a fluid reservoir 14. Though the well bore 12 shown in FIG. 1 is a vertical well bore 12, well bores 12 may include several changes in direction and may include slanted or horizontal sections. A well bore casing 16 is typically inserted into the well bore 12 to provide support. Fluid from the reservoir 14 may then be pumped to the surface 18 for collection, separation, and refining. Though there are many possible ways to pump fluids from an underground reservoir 14 to the surface 18, one technique is to use an electrical submersible pump (ESP), as shown in FIG. 1.

When using an ESP, an ESP assembly or system 20 is fed through the well bore casing 16 toward the reservoir 14. The ESP assembly 20 may include a pump 22, an intake 24, a sealing assembly 26, an electric motor 28, and a sensor 30. Power may be drawn from a power source 32 and controlled by a controller 34. The power source 32 shown in FIG. 1 is a utility grid, but power may be provided in other ways (generator, batteries, etc.). The controller 34 may be a Variable Speed Drive, a Variable Frequency Drive, or some other controller used to control the frequency and/or speed of the motor 28. The power may then be stepped up or down with a transformer 36, and provided to the ESP assembly 20 via a cable 38 that is fed through the well bore casing 16 from the surface 18 to the ESP assembly 20. The motor 28 then draws power from the cable 38 to drive the pump 22. The motor 28 may be an induction motor, a permanent magnet motor, or any other type of electric motor.

The pump 22 may be a centrifugal pump with one or more stages. The intake 24 acts as a suction manifold, through which fluids 14 enter before proceeding to the pump 22. In some embodiments, the intake 24 may include a gas separator. A sealing assembly 26 may be disposed between the intake 24 and the motor 28. The sealing assembly protects the motor 28 from well fluids 14, transmits torque from the motor 28 to the pump 22, absorbs shaft thrust, and equalizes the pressure between the reservoir 14 and the motor 28. Additionally, the sealing assembly 26 may provide a chamber for the expansion and contraction of the motor oil resulting from the heating and cooling of the motor 28 during operation. The sealing assembly 26 may include labyrinth chambers, bag chambers, mechanical seals, or some combination thereof.

The sensor 30 is typically disposed at the base of the ESP assembly 20 and collects real-time system and well bore parameters. Sensed parameters may include pressure, temperature, motor winding temperature, vibration, current leakage, discharge pressure, and so forth. The sensor 30 may provide feedback to the motor controller 34 and alert users when one or sensed parameters fall outside of expected ranges.

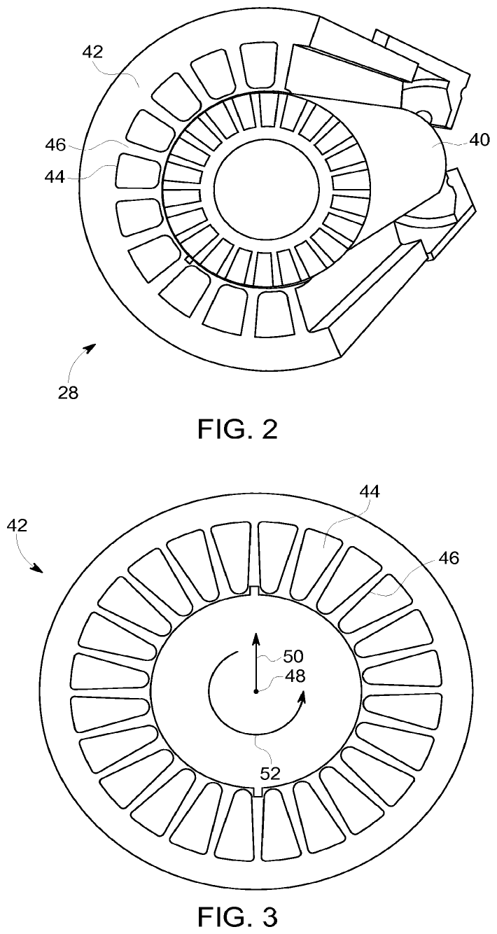

As shown in FIG. 2, the motor 28 typically includes a rotor 40 that rotates within a stator 42. FIG. 3 shows a cross-sectional view of a typical closed-slot stator 42. As shown in FIGS. 2 and 3, the stator 42 may have a number of slots 44 separated by stator teeth 46, disposed circumferentially about the axis 48 of the stator 42. Coils of magnetic coils of wire wind through the stator slots 44. The motor may be filled with oil for lubrication, cooling, and insulation. In some embodiments, the rotor 40 may include multiple rotor sections, separated by bearings, which help maintain spacing between the rotor 40 and the stator 42. Additionally, the space between rotor sections may provide circumferential channels through which oil may flow. A radial direction 50 and a circumferential direction 52 are also shown. Given the aspect ratios of motors 28 used in ESP systems—generally between 3.5 and 6.0 inches in diameter and as long as 40 feet long—the motor 28 may include bearings periodically along the length of the motor 28. The stator 42 may include coils of magnetic wire wound or threaded within the stator 42. The number of coils corresponds to the number of phases being used (e.g., a three-phase motor 28 uses a multiple of three magnetic coils connected into three phases).

Installing the wire coils on the closed stator 42 shown in FIGS. 2 and 3 involves passing a wire attached to steel rods through a first stator slot 44 from a first end of the stator 42 to a second end of the stator 42, along the entire length of the stator 42, inserting the wire into a second stator slot 44, threading the wire through the entire length of the stator 42 back to the first end, and continuing this sewing-like process until the winding is complete. The process is then repeated multiple times such that each slot 44 contains the designed number of wires (typically more than five). When performed on electric motors used in ESP assemblies 20, which can reach up to 40 feet in length, this winding process can be time consuming and expensive. The long length of wire required, and the distance traveled by the head of the wire before reaching its final position may result in damage to the wire itself or the insulation surrounding the wire, which may result in reduced life of the winding. Finally, because a wire must pass through the entire length of the stator, and because there is frictional drag between wires, the density of wires that may be achieved in each slot is quite low.

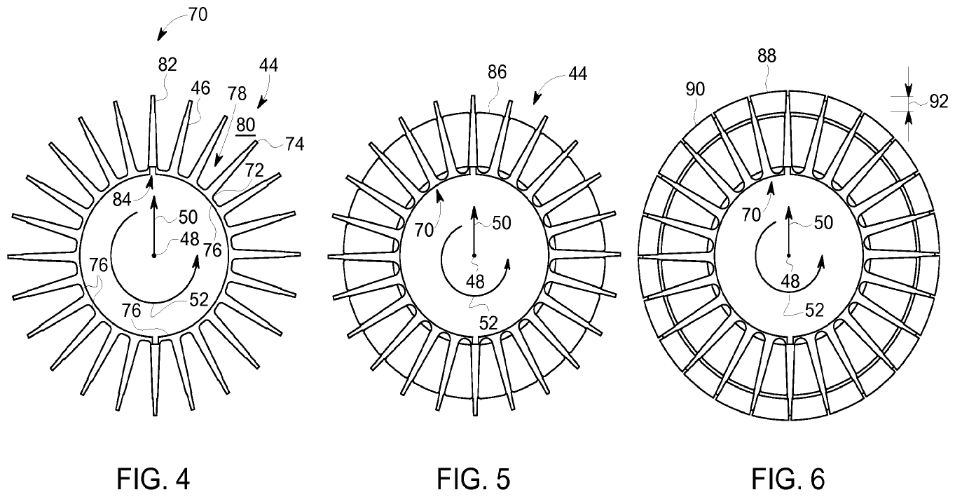

Accordingly, an improved stator 42 design and method of manufacture are disclosed that decrease the time and cost of manufacturing a stator 42, while improving the reliability of the stator 42. One embodiment of the disclosed open-slot stator 42 design is shown in FIGS. 4-6. FIG. 4 shows one embodiment of a stator core 70. The stator core may include a plurality of teeth 46 disposed circumferentially about the rotor axis 48. Each tooth 46 extends in a radial direction 50 from a proximal end 72 to a distal end 74. Each tooth 46 also extends in the axial direction along the axis of rotation 48. The proximal ends 72 of adjacent teeth 46 may be connected by a bridge 76. The teeth 46 define a plurality of slots 44, each having a proximal end 78 and a distal end 80, wherein the distal end 80 of the slots 44 may be open. In some embodiments, the teeth 46 may have a shoulder 82, wherein the width (in the circumferential direction 52) of the tooth 46 decreases. In some embodiments, the stator includes recesses 84 that interface with the rotor bearings to hold the bearings in place and allow the rotor 40 to spin.

In some embodiments, the stator core 70 may be made a plurality of laminated layers stacked axially such that the stator core 70 is magnetically conductive but not electrically conductive. In some embodiments, the stacked laminate layers may have the same cross section as the stator core 70, as shown in FIG. 4, and stacked axially 48. However, other stacking configurations may be possible. Stacked laminate layers may be electrical sheet steel (e.g., grade M19) of a thickness appropriate for the motor performance objectives. M19 is commonly available in 24 gauge (0.018 inches thick) and 26 gauge (0.014 inches thick), but other thicknesses may be used. The stator core 70 may extend the entire length of the electric motor 28. In other embodiments, the stator 42 may include multiple stator cores 70 stacked axially and separated by bearings.

FIG. 5 shows the stator core 70 with windings 86 inserted into the slots 44. The windings 86 are inserted radially 50 inward through openings in the distal ends 80 of the stator slots 44. The windings 86 in the present embodiment are made of copper, but the windings 86 may be made of any conductive material, and may include multiple wires, or a single unitary winding 86 (as shown in FIG. 5) disposed within a single slot 44. In the present embodiment, the individual coils may be 11 gauge, 11.5 gauge, or some other thickness.

FIG. 6 shows the stator core 70 with windings 86 in the slots 44 and magnetic keystones 88 (e.g., keystones) closing the distal ends 80 of the slots 44. In the embodiment shown in FIG. 6, each magnetic keystone 88 sits on the shoulders 82 of two adjacent stator teeth 46, and the outside surfaces 90 of the magnetic keystones 88 extend radially outward beyond the distal ends 74 of the teeth 46 by a distance 92. In some embodiments, 0%, 5%, 10%, 15%, 20%, 25%, 30%, 35%, 40%, 45%, 50%, or more of the magnetic keystone 88 may extend radially 50 beyond the distal ends 74 of the teeth 46. This configuration creates channels extending axially between the magnetic keystones, enabling better oil flow through the electric motor 28 and also preventing magnetic flux from entering into the stator housing or other surrounding pipe. The shoulders 82 may also help in positioning the magnetic keystones 88 during assembly. In other embodiments, the teeth 46 may not have shoulders 82, or the distal ends 74 of the teeth 46 may extend nearer to, up to, or beyond the outer surface 90 of the magnetic keystones 88. As will be discussed later, in some embodiments, multiple magnetic keystones 88 may be connected to one another. As with stator core 70, the magnetic keystones 88 may be made of punched and laminated stacks of material in order to make the magnetic keystones 88 magnetically conductive but not electrically conductive. The punched and stacked laminated layers used for the magnetic keystones 88 may be of a different thickness than those used for the stator core 70. The stack direction of the laminated layers for the magnetic keystones 88 may be the same as for the stator core 70 (i.e., stacked axially), or different (e.g., radial 50, circumferential 52, etc.). The stacked laminate layers for the magnetic keystones 88 may be electrical sheet steel (e.g., grade M19), of a suitable thickness for the motor performance objectives. M19 steel is commonly available in 24 gauge (0.018 inches thick) and 26 gauge (0.014 inches thick), but other thicknesses may be possible. In some embodiments, the laminate layers for the stator core 70 and the magnetic keystones 88 may be of different thicknesses so edges do not align. Each magnetic keystone 88 may extend axially 48 the entire length of the stator 42, or multiple magnetic keystones 88 may combine to extend the length of the stator 42. In some embodiments, there may be spaces between magnetic keystones 88. For example, spaces between magnetic keystones may align with bearings in the rotor 40 and act as a radial cooling duct, through which oil or another cooling fluid flows.

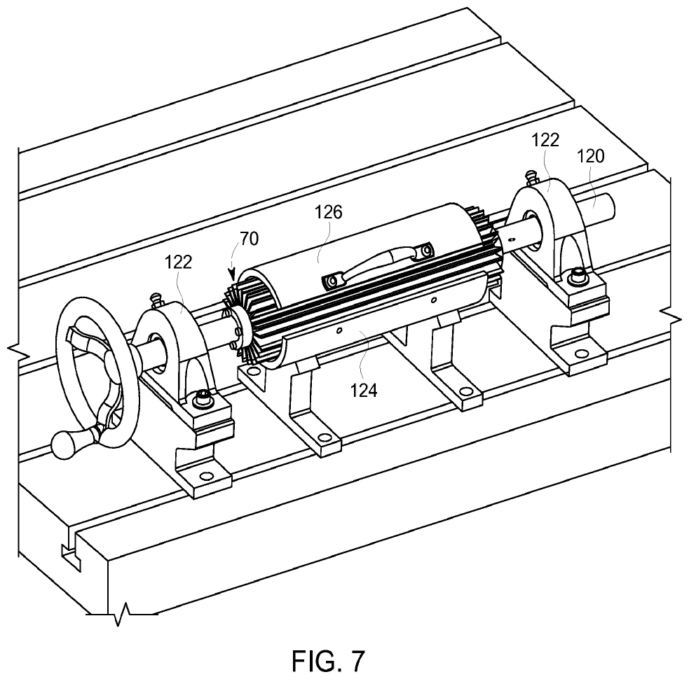

FIGS. 7-14 show a first step of one embodiment of a manufacturing or assembly process for the stator 42. In FIG. 7, the stator core 70 is mounted on a mandrel 120 or other shaft-shaped object. In some embodiments, the stator core 70 may be attached to the mandrel via a clamp, or a keyed interface on the stator (e.g., recesses 84). Either end of the mandrel 120 is supported by a bearing support 122 (e.g., bearing pedestal) that allows the mandrel 120 and the stator core 70 to rotate. A cradle 124 and a cover 126 combine to extend circumferentially about the exterior of the stator core 70. The bearing pedestals 122, the cradle 124, and possibly other components may be attached to a table (e.g., t-slot table), or some other surface that allows for the precise positioning of the components. In the embodiment shown in FIG. 7 the cradle 124 and cover 126 combine to cover all but 2 slots 44 of the stator core. However, in other embodiments, the manufacturing/assembly tooling may cover more or fewer slots 44.

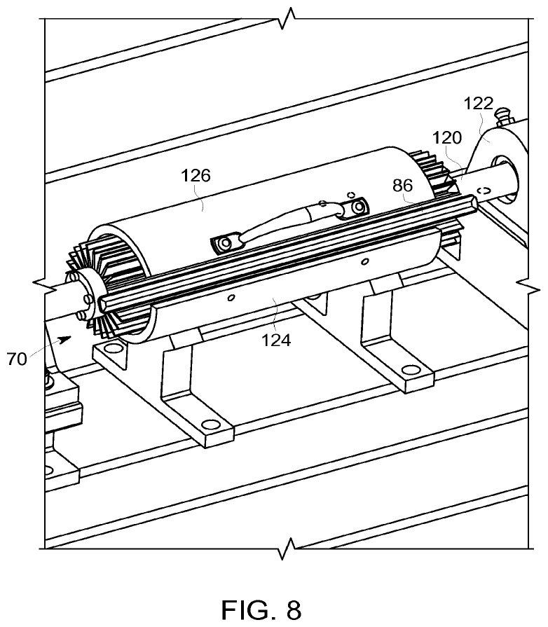

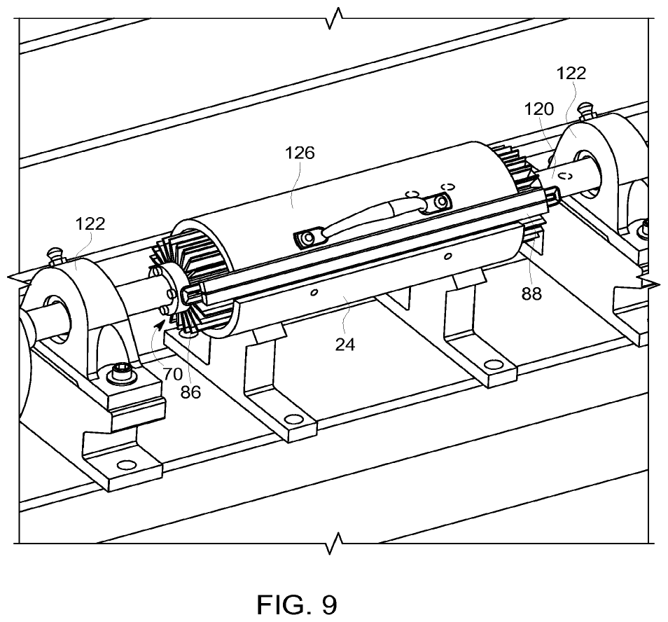

As shown in FIG. 8, coil sides (e.g., groups of wires 86) are placed in the two open slots 44 by inserting the coil sides 86 through the distal ends 80 of the slots 44. The coil sides 86 may be a single, unitary, pre-formed object, or a collection of magnetic wires 86. In some embodiments, coil sides 86 may span multiple slots, with suitable adjustments in the fixtures. In some embodiments, coil sides 86 for two slots 44 may be joined at one or both ends such that one coil side 86 runs axially in one direction, and the second coil side 86 runs axially in the opposite direction. As shown in FIG. 9, once the coil sides 86 are in place, the magnetic keystones 88 are inserted over the coil sides 86, effectively closing the distal end 80 of each slot 44 and holding the coil sides 86 in the slots 44. In some embodiments, the magnetic keystones may snap into place. The mandrel 120 and the stator core 70 are then rotated such that the slots 44 that have been filled with a coil side 86 and magnetic keystone 88 pass under the cover 126, exposing the next two slots 44. The cover 126 holds the coil sides 86 and the magnetic keystones 88 in place as the remaining slots 44 are populated. As previously stated, this is merely one embodiment. In other embodiments, different numbers of slots 44 may be filled at a time. For example, 1, 2, 3, 4, 5, 6, 7, 8, 9, or 10 slots 44 may be filled at a given time.

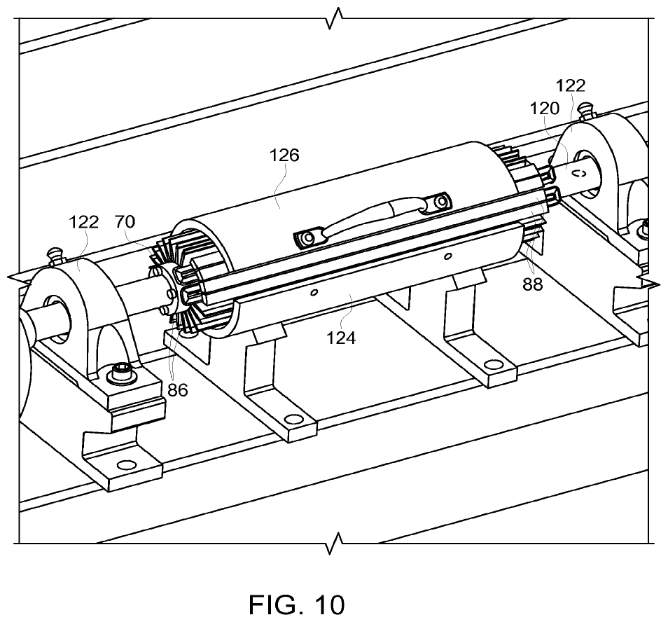

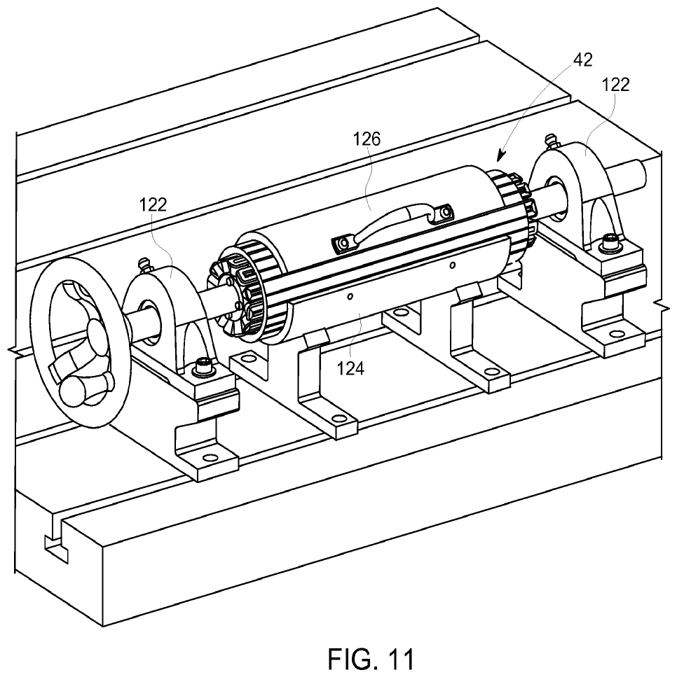

FIG. 10 shows the two adjacent slots 44 having the initially installed coil sides 86 and magnetic keystones 88 rotated underneath the cover, and being held in place by the cover 126. The two exposed slots 44 have also been filled with coil sides 86 and magnetic keystones 88. This process of filling two slots 44 with coil sides 86 and magnetic keystones 88, and then rotating those two slots 44 up under the cover 126 continues until all of the slots have been filled, as shown in FIG. 11. It should be understood, however, that the embodiment shown in FIG. 10 is merely one embodiment and that other embodiments may exist. For example, embodiments may exist in which 1, 2, 3, 4, 5, 6, 7, 8, 9, 10, or any other number of slots 44 are filled between rotations of the stator core 70.

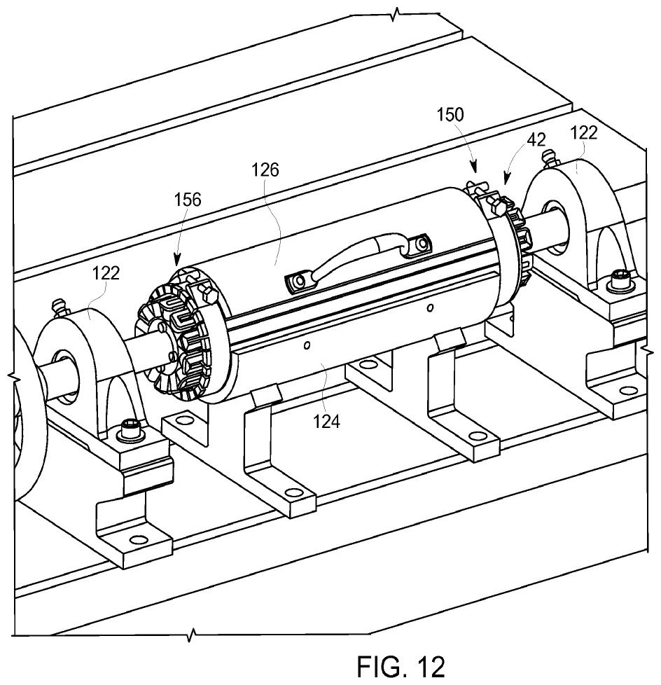

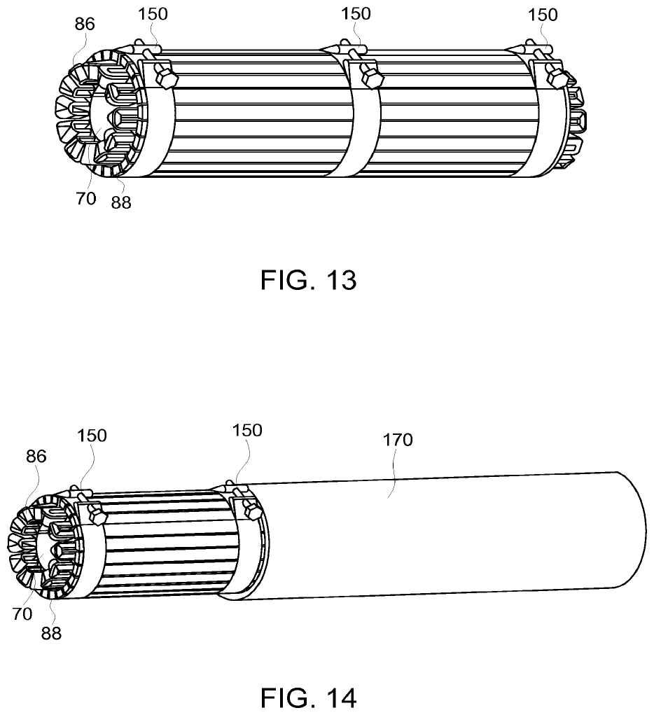

As shown in FIG. 12, once all slots 44 are filled with coil sides 86 and magnetic keystones 88, one or more band clamps 150 are placed circumferentially around the stator 42 assembly to hold the coil sides 86 and magnetic keystones in place. In the embodiment shown in FIG. 12, a band clamp 150 is placed on each end of the stator 42 assembly where the stator 42 assembly extends beyond the cradle 124 and cover 126. As shown in FIG. 13, more band clamps 150 may be added to the stator 42 assembly once it is removed from the cradle 124 and cover 126. FIG. 14 shows the stator 42 assembly being inserted into a stator housing 170. As the stator 42 assembly is inserted into the stator housing 170, band clamps 150 are removed.

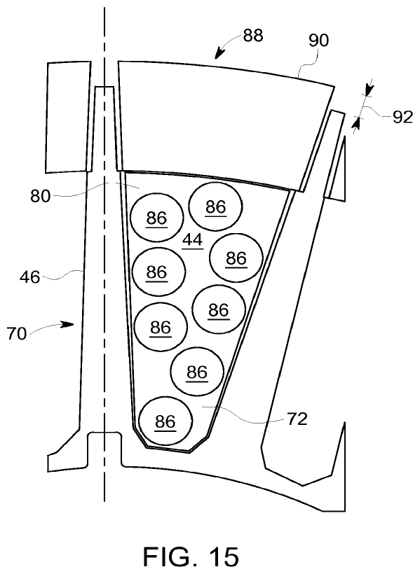

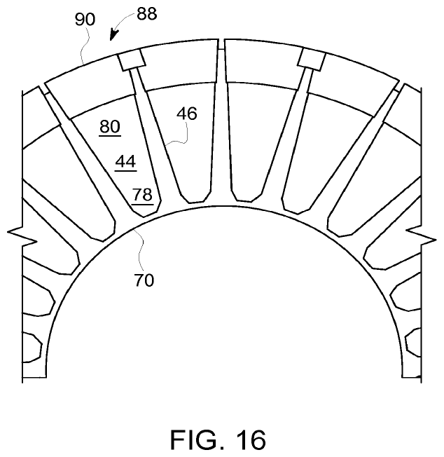

FIG. 15 shows one embodiment of a slot 44 filled with windings 86. In typical electric motors with closed stators, as shown in FIGS. 2 and 3, a steel rod is used like a sewing needle to thread wires 86 through the slots 44 of the stator 42. The frictional drag between the wire 86 being threaded and the wires 86 already in the slot 44 limits the fill factor of the stator slot 44 that may achieved by this method. In the present (i.e., open slot 44) embodiment, because windings 86 are inserted in the radial direction 50 through the distal end 80 of the slot 44, rather than threaded through the entire length of the stator core 70 axially 48, the fill factor of the stator 42 is improved (i.e., each slot contains more copper), which correspondingly improves the power density and efficiency of the electric motor 28. For clarity, the embodiment shown in FIG. 15 includes a plurality of individual windings 86 in slot 44. However, as previously discussed, embodiments with single, unitary coils 86 are also possible and may result in similar increases in fill factor.

FIG. 16 shows an alternate embodiment wherein multiple magnetic keystones 88 may be joined together. In the embodiment shown in FIG. 16, two adjacent magnetic keystones are joined. However, it should be understood that other embodiments may be possible. For example, 2, 3, 4, 5, 6, 7, 8, 9, 10, 12, 14, 16, 18, 20, 22, 24, or any other number of magnetic keystones may be joined together such that a part may contain multiple magnetic keystones 88 that extend circumferentially about the stator 42. In one possible embodiment, a full ring of magnetic keystones may be used and slipped over one end of the stator core 70 once the windings 86 are installed.

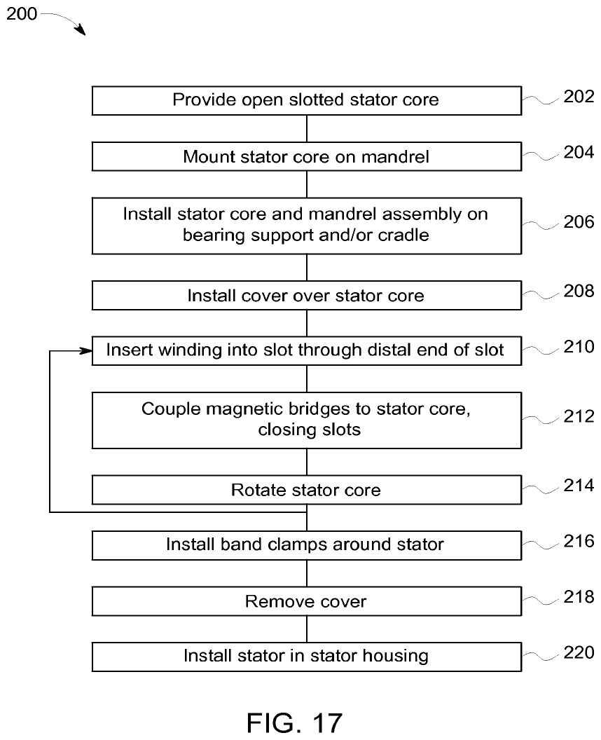

FIG. 17 is a flow chart for a process 200 of manufacturing or assembling a stator 42, similar to the previous discussion with regard to FIGS. 7-14. As previously discussed, this is merely one embodiment. As such, it should be understood that these examples are not intended to limit the scope of the disclosure and that other similar processes may be possible.

In block 202, a stator core 70 is provided. The stator core 70 may include a plurality of teeth 46 disposed about a rotational axis 48, each tooth 46 of the plurality of teeth may extend in a radial direction 50 from a proximal end 78 to a distal end 80. A plurality of bridges 76, each disposed between two adjacent teeth 46, connect the proximal ends 78 of adjacent teeth 46. The plurality of teeth 46 and bridges 76 define a plurality slots 44. Each slot may be closed at the proximal end 78 and open at the distal end 80. In block 204, the stator core 70 is mounted on a mandrel 120 or other shaft-shaped object (e.g., as shown in FIG. 7).

In block 206, the mandrel 120 and stator core 70 are installed on bearing pedestals 122 and a cradle 124 (e.g., as shown in FIG. 7). As previously discussed, either end of the mandrel 120 is supported by a bearing pedestal 122 that allows the mandrel 120 and the stator core 70 to rotate.

In block 208, the cover 126 is installed (e.g., as shown in FIG. 7). The cradle 124 and a cover 126 combine to extend circumferentially 52 partially around the stator core 70 in a circumferential direction 52. For example, in the embodiment shown in FIG. 7 the cradle 124 and cover 126 combine to cover all but 2 slots 44 of the stator core. It should be understood, however, that this is merely one embodiment and that in other embodiments, the cradle 124 and cover 126 may combine to cover all but 1, 3, 4, 5, 6, 7, 8, 9, 10, or more slots 44 of the stator core.

In block 210, windings 86 (e.g., coils) are placed in the first slot 44 by inserting the coil side 86 through the distal end 80 of the slot 44 (e.g., as shown in FIG. 8). The coil sides 86 may be a single, unitary, pre-formed object, or a collection of magnetic coils.

In block 212, a magnetic keystone 88 is inserted over the coil side 86, effectively closing the distal end 80 of each slot 44 and holding the coil sides 86 in the slots 44 (e.g., as shown and discussed with regard to FIG. 9).

In block 214, the mandrel 120 and the stator core 70 are then rotated such that the slots 44 that have been filled with a coil side 86 and magnetic keystone 88 pass under the cover 126, exposing the next two slots 44 (e.g., as shown and discussed with regard to FIG. 10, but noting that the slots need not be adjacent). The cover 126 holds the coil sides 86 and the magnetic keystones 88 in place as the remaining slots 44 are populated. As previously stated, this is merely one embodiment. In other embodiments, different numbers of slots 44 may be filled at a time. For example, 1, 2, 3, 4, 5, 6, 7, 8, 9, or 10 slots 44 may be filled at a given time.

The process 200 then returns to block 210, where additional windings 86 and magnetic keystones 88 are installed, and the stator core 70 and mandrel 120 rotated until the each slot 44 has been populated (e.g., as shown and discussed with regard to FIGS. 10 and 11).

In block 216, one or more band clamps are installed circumferentially about the stator core (e.g., as shown and discussed with regard to FIGS. 12 and 13). A band clamp 150 may be placed on each end of the stator 42 assembly where the stator 42 assembly extends beyond the cradle 124 and cover 126. More band clamps 150 may be added to the stator 42 assembly once it is removed from the cradle 124 and cover 126. In block 218, the cover 126 may be removed.

In block 220, the stator 42 assembly is installed in a stator housing 170. This was shown and discussed with regard to FIG. 14. The casing 170 may be a well bore casing 16 or a separate stator housing 170.

Technical effects of the disclosure include a stator design and process of manufacturing a stator that reduce the time and cost associated with manufacturing. The techniques may be applied to stators for permanent magnet motors, induction motors, or other electric machines with a stator. Additionally, the techniques disclosed herein do not require threading a winding through multiple slots, thus reducing damage to the insulation surrounding the windings, resulting in a more reliable electric motor. Furthermore, by inserting the windings radially into the slots, rather than threading the windings through axially, the copper fill factor for each slot may be increased, resulting in a motor with greater power density.

This written description uses examples to disclose the claimed subject matter, including the best mode, and also to enable any person skilled in the art to practice the subject matter, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of manufacturing an electric machine stator comprising the steps of:
providing a stator core, the stator core comprising a plurality of teeth disposed about an axis of the stator core, each tooth of the plurality of teeth extending in a radial direction from a proximal end to a distal end, and a plurality of bridges, wherein each bridge of the plurality of bridges is disposed between two adjacent teeth and connects the proximal ends of the two teeth, wherein the plurality of teeth and the plurality of bridges define a plurality slots;
inserting a first winding into a first slot of the plurality of slots; and
coupling a first magnetic keystone to the stator core to block removal of the first winding.

2. The method of claim 1, further comprising the steps of:
inserting a plurality of successive windings into respective slots of the plurality of slots; and
coupling respective magnetic keystones to the stator core to block removal of the plurality of windings.

3. The method of claim 1, further comprising the step of installing the stator core into a stator housing.

4. The method of claim 1, wherein the step of inserting the first winding into the first slot of the plurality of slots further comprises radially inserting the first winding into the first slot of the plurality of slots.

5. A method for manufacturing an electric motor, the method comprising the steps of:
providing a stator core that includes a plurality of open slots, wherein the stator core has a plurality of teeth disposed about an axis of the stator core, each tooth of the plurality of teeth extending in a radial direction from a proximal end to a distal end, and a plurality of bridges, wherein each bridge of the plurality of bridges is disposed between two adjacent teeth of the plurality of teeth to connect the proximal ends of the two adjacent teeth to form a corresponding one of the plurality of open slots;
providing a plurality of windings;
radially inserting each of the plurality of windings into a corresponding one of the plurality of open slots; and
inserting a magnetic keystone over each of the plurality of windings to enclose each of the plurality of windings in a corresponding one of the plurality of open slots.

6. The method of claim 5, wherein the step of providing a plurality of windings comprises providing a plurality of pre-formed unitary windings.

7. The method of claim 5, wherein the step of providing a plurality of windings comprises providing a plurality of windings wherein each of the plurality of windings comprises a collection of individual magnetic coils.

8. The method of claim 5, wherein the step of providing a plurality of windings further comprises connecting two or more of the plurality of windings to form connected groups of windings.

9. The method of claim 8, wherein the step of radially inserting each of the plurality of windings into a corresponding one of the plurality of open slots comprises inserting a connected group of windings into a corresponding set of the plurality of the open slots.

10. The method of claim 8, wherein the step of connecting two or more of the plurality of windings to form connected groups of windings comprises the step of joining each of the plurality of windings on one end to place the connected groups of windings in a series configuration.

11. The method of claim 8, wherein the step of connecting two or more of the plurality of windings to form connected groups of windings comprises the step of joining each of the plurality of windings on one both ends to place the connected groups of windings in a parallel configuration.

12. The method of claim 5, wherein the step of inserting a magnetic keystone over each of the plurality of windings further comprises snapping the magnetic keystone into place within the teeth.

13. A method for manufacturing an electric motor, the method comprising the steps of:
providing a stator core that includes a plurality of open slots formed between two adjacent teeth that extend radially outward from a common bridge;
temporarily mounting the stator on a rotatable shaft;
providing a plurality of windings;
radially inserting one of the plurality of windings into a corresponding one of the plurality of open slots;
inserting a magnetic keystone over the winding to enclose the winding;
rotating the stator core on the rotatable shaft to reveal one of the remaining open slots;
repeating the steps of radially inserting and enclosing one of the plurality of windings into a corresponding one of the plurality of open slots; and
removing the stator core from the rotatable shaft when each one of the plurality of open slots contains a corresponding winding enclosed by a magnetic keystone.

14. The method of claim 13, further comprising the step placing a cover over the stator core before the step of radially inserting the first of the plurality of windings into a corresponding one of the plurality of open slots.

15. The method of claim 13, further comprising the step of applying one or more clamps around the stator core before the stator core is removed from the rotatable shaft.

16. The method of claim 15, further comprising the steps of:
inserting the stator core into a motor housing; and
removing the one or more clamps from the stator core.

17. The method of claim 13, wherein the step of providing a plurality of windings comprises providing a plurality of pre-formed unitary windings.

18. The method of claim 13, wherein the step of providing a plurality of windings comprises providing a plurality of windings wherein each of the plurality of windings comprises a collection of individual magnetic coils.

19. The method of claim 13, wherein the step of providing a plurality of windings further comprises connecting two or more of the plurality of windings to form connected groups of windings.

20. The method of claim 19, wherein the step of radially inserting each of the plurality of windings into a corresponding one of the plurality of open slots comprises inserting a connected group of windings into a corresponding set of the plurality of the open slots.
